(19) United States
(12) Patent Application Publication
(10) Pub. No.: US 2025/0233270 A1
(43) Pub. Date: Jul. 17, 2025

(54) FUSE DEVICE FOR JOINING BATTERY CELLS, AND METHOD OF FORMING

(71) Applicant: Molex, LLC, Lisle, IL (US)

(72) Inventor: Ronald C Hodge, Montgomery, IL (US)

(21) Appl. No.: 18/853,723

(22) PCT Filed: May 23, 2023
(86) PCT No.: PCT/IB2023/055310

§ 371 Date: Oct. 3, 2024

Related U.S. Application Data
(60) Provisional application No. 63/345,559, filed on May 25, 2022.

(51) Int. Cl. H01M 50/502; H01H 69/02; H01H 85/20; H01M 50/583

(52) U.S. Cl. CPC H01M 50/502; H01H 69/02; H01H 85/2045; H01M 50/583

(57) ABSTRACT

A fuse device for coupling terminals of battery cells are formed an ASEP manufacturing process. The fuse device is formed by stamping and forming a lead frame having first and second conductive plates extending into an opening thereof; overmolding a first insulative housing onto a first section of each of the plates without overmolding a second section of each of the plates, thereby coupling the plates together; forming a trace on the first insulative housing which is mechanically and electrically coupled to the plates; overmolding an insulative second housing over at least the trace thereby forming a subassembly; singulating the subassembly from the from the lead frame; mechanically and electrically coupling the second sections to third and fourth conductive plates.

### RELATED APPLICATIONS

This application claims priority to U.S. Provisional Application No. 63/345,559 filed May 25, 2022, which is incorporated herein by reference.

### FIELD OF THE DISCLOSURE

This disclosure relates to a fuse device for joining like terminals of battery cells, for example, positive terminals, and the method of manufacturing same. More specifically, this disclosure relates to fuse device for joining like terminals of battery cells formed using an Application Specific Electronics Packaging (“ASEP”) manufacturing process.

### DESCRIPTION OF RELATED ART

Some customers require fuses between battery cells. Typical fuses can be expensive. Connecting metallization is often as a fuse. In a cell contacting system that uses stamped terminal plates/busbars with varying lengths and thus bulk resistance, a reduced cross-section may be needed to “tune” the current of the fuse versus time “blow” profile that does not disconnect prematurely. This variation would typically need to be handled in the stamping die with various inserts and configurations. This approach does not allow the molten metal to be contained, which may cause cascading damage to other cells and electrical connections (i.e. shorts).

Application Specific Electronic Packaging (“ASEP”) devices and manufacturing processes have been developed by the Applicant, and are useful for the creation of electronics modules. Metal components integrated into ASEP devices are highly conductive so the metal components provide an optimal path for carrying high current, as well as removing heat very efficiently. ASEP manufacturing processes have previously been described and illustrated in U.S. Pat. Nos. 10,433,428, 10,667,407, 10,905,014 and 11,503,718, the disclosures of which are incorporated herein by reference.

### BRIEF DESCRIPTION OF THE DRAWINGS

The present disclosure is illustrated by way of example, and not limited, in the accompanying figures in which like reference numerals indicate similar elements and in which:

FIG. 1 depicts a top perspective view of a fuse device mounted to battery cells;

FIG. 2 depicts a cross-sectional view of the fuse device showing an embodiment of a trace;

FIG. 3 depicts another cross-sectional view of the fuse device;

FIG. 4 depicts a reel-to-reel assembly process for making a subassembly the fuse device;

FIG. 5 depicts additional steps for making the fuse device from the subassembly and coupling the fuse device to the battery cells;

FIG. 6 depicts a flow chart illustrating the reel-to-reel assembly process; and

FIGS. 7-9 depict cross-sectional views of the fuse device showing alternate embodiments of the trace.

### DETAILED DESCRIPTION

While the disclosure may be susceptible to embodiments in different forms, it is shown in the drawings and herein which is described in detail, specific embodiments with the understanding that the present disclosure is to be considered an exemplification of the principles of the disclosure and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

Directional terms such as front, rear, horizontal, vertical and the like are used for ease in explanation, and do not denote a required orientation in use.

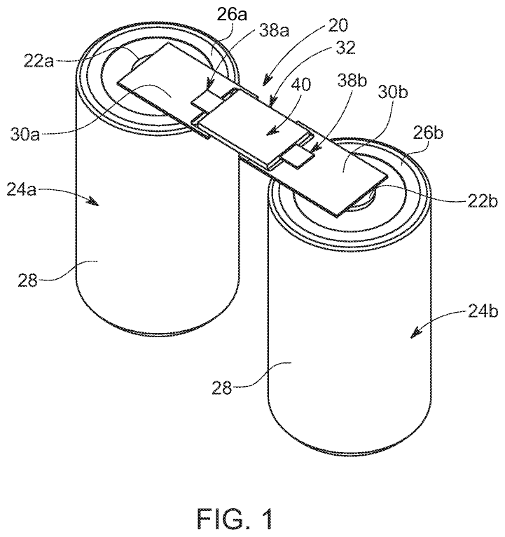

A fuse device is designed to be electrically connected to conductive like terminals, of a pair of battery cells, see FIG. 1. The present disclosure uses an Application Specific Electronic Packaging (“ASEP”) manufacturing method to create the fuse device which allows the manufacturer to easily tune the fuse device for each situation and allows for common stamped conductive plates. The fuse device has a surface onto which a laser pattern is scribed and then plated. The fuse device has an insulative housing overmolded to increase durability and provide environmental protection. The fuse metallization of the fuse device is encapsulated within an overmolded outer housing to minimize cascading damage to other battery cells and electrical connections (i.e. shorts) when “blown”. Different shapes and patterns of the conductive trace can be easily programmed with laser programming. In addition, different sizes for smaller or larger currents of the conductive trace can be easily made. Independent multiple fuse part numbers can be put into common stampings for fusing at various current-time profiles. The unique properties of ASEP allow for the creation of an assembly that has the features of a printed circuit board and the features of an electrical connector, produced in a single, high volume, compact, and low-cost assembly. The ASEP manufacturing process is disclosed in, for example, U.S. Pat. Nos. 10,433,428, 10,667,407, 10,905,014 and 11,503,718.

A fuse device 20 electrically connects conductive like terminals, for example, positive terminals 22a, 22b of a pair of battery cells 24a, 24b. Each battery cell 24a, 24b is conventional and has a positive terminal 22a, 22b surrounded by a negative terminal 26a, 26b within a battery case 28. The battery case 28 may be cylindrical. The positive and negative terminals 22a, 22b, 26a, 26b are exposed at the top end of the battery case 28. A lower end of the battery case 28 may be planar.

The fuse device 20 includes first and second conductive plates 30a, 30b which are mechanically and electrically coupled to the respective positive terminals 22a, 22b (or the respective negative terminals 26a, 26b) of the battery cells 24a, 24b, and a bridge assembly 32 which is mechanically and electrically coupled to the first and second conductive plates 30a, 30b. The bridge assembly 32 is formed of an inner, first insulative housing 34 having a conductive trace 36 thereon, first and second conductive plates 38a, 38 which are mechanically and electrically coupled to the conductive trace 36, and an outer, second insulative housing 40. The first and second conductive plates 38a, 38 are mechanically and electrically coupled to the respective first and second conductive plates 30a, 30b. The first and second conductive plates 30a, 30b may each be generally U-shaped.

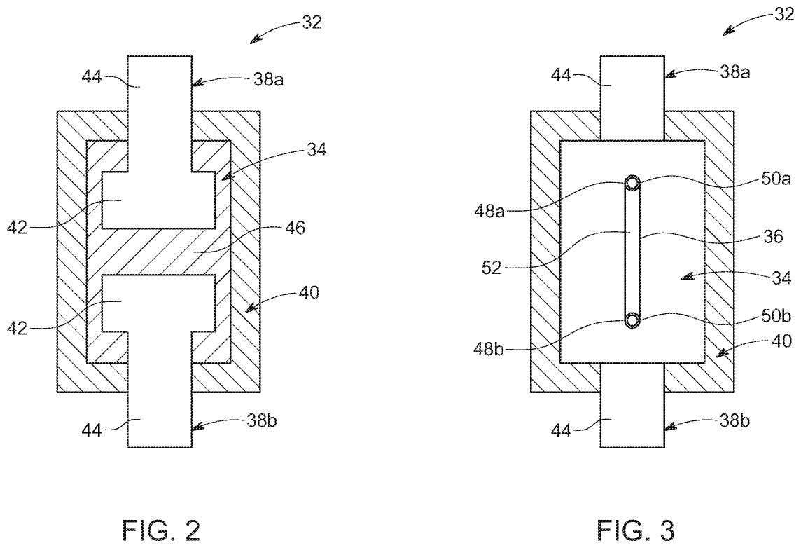

As shown in the cross-sectional view of FIG. 2, each conductive plate 38a, 38b has a first portion 42 which is within the inner and outer housings 34, 40 and a second portion 44 which is partially within the inner and outer housings 34, 40 and has a section that extends outward from opposite ends of the outer housing 40. The first portions 42 are spaced apart from each other within the inner housing 34 such that a space 46 is provided therebetween. The conductive plates 38a, 38b can take a variety of shapes. As shown, each conductive plate 38a, 38b is planar and generally T-shaped. The first portions 42 may be rectangular, square, circular, triangular, etc., for example. The second portions 44 may be rectangular or square, for example. The conductive plates 38a, 38b can be rectangular or square. By providing a non-linear first portion 42, this deters pullout of the conductive plates 38a, 38b from the inner housing 34.

The inner housing 34 generally encapsulates the first portions 42 and fills the space 46. As shown in the cross-sectional view of FIG. 3, the inner housing 34 has a first through hole 48a which extends from a top surface thereof and exposes the first portion 42 of the first conductive plate 38a, and a second through hole 48b which extends from the top surface and exposes the first portion 42 of the second conductive plate 38b.

The conductive trace 36 is formed by plating 50a, 50b on the wall forming the respective through hole 48a, 48b, and plating 52 on the top surface of the inner insulative housing 34. The plating 50a is mechanically and electrically coupled to the first portion 42 of the first conductive plate 38a, and the plating 50b is mechanically and electrically coupled to the first portion 42 of the second conductive plate 38b. The plating 50a, 50b and the plating 52 are mechanically and electrically coupled together. Therefore, an electrical path is formed from the conductive plate 38a, through the plating 50a, through the plating 52, through the plating 50b, and through the conductive plate 38b.

The outer housing 40 encapsulates the conductive trace 36. As shown, the outer housing 40 further encapsulates the sections of the first portions 42 of each conductive plate 38a, 38b that are exposed from the inner housing 34, and encapsulates the inner housing 34. In an embodiment, the outer housing 40 does not fully overlay the inner housing 34; the outer housing 40 only overlays the portions of the inner housing 34 which has the conductive trace 36. The second portions 44 are not encapsulated and extend outward from opposite ends of the outer housing 40.

The second portion 44 of the first conductive plate 38a is mechanically and electrically coupled to the first conductive plate 30a, and the second portion 44 of the second conductive plate 38b is mechanically and electrically coupled to the second conductive plate 30b.

The first conductive plate 30a is mechanically and electrically coupled to the positive terminal 22a of the first battery cell 24a, and the second conductive plate 30b is mechanically and electrically coupled to the positive terminal 22b of the second battery cell 24b. Therefore, the positive terminal 22a of the battery cell 24a is electrically coupled to the positive terminal 22b of the battery cell 24b by the fuse device 20. Alternatively, but not shown, the first conductive plate 30a is mechanically and electrically coupled to the negative terminal 26a of the first battery cell 24a, and the second conductive plate 30b is mechanically and electrically coupled to the negative terminal 26b of the second battery cell 24b. Therefore, the negative terminal 26a of the battery cell 24a is electrically coupled to the negative terminal 26b of the battery cell 24b by the fuse device 20.

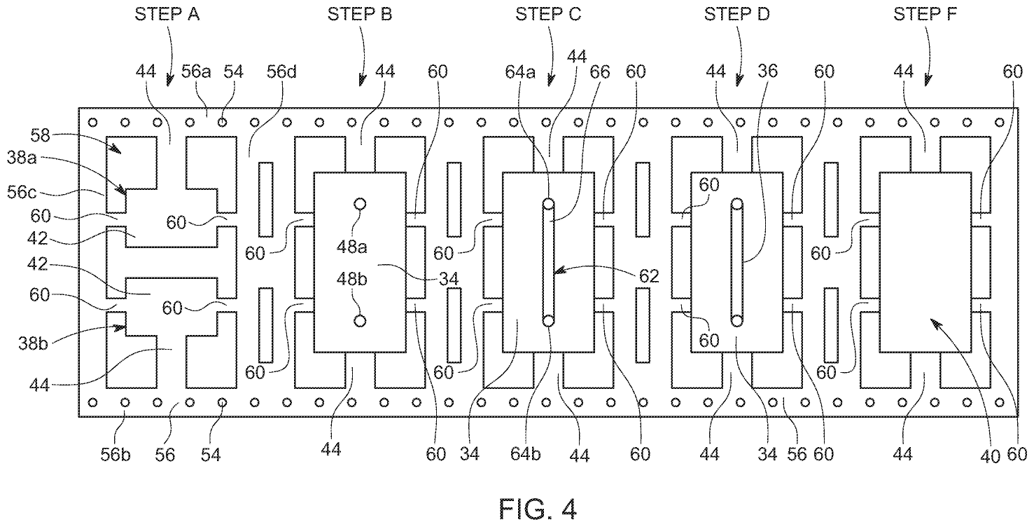

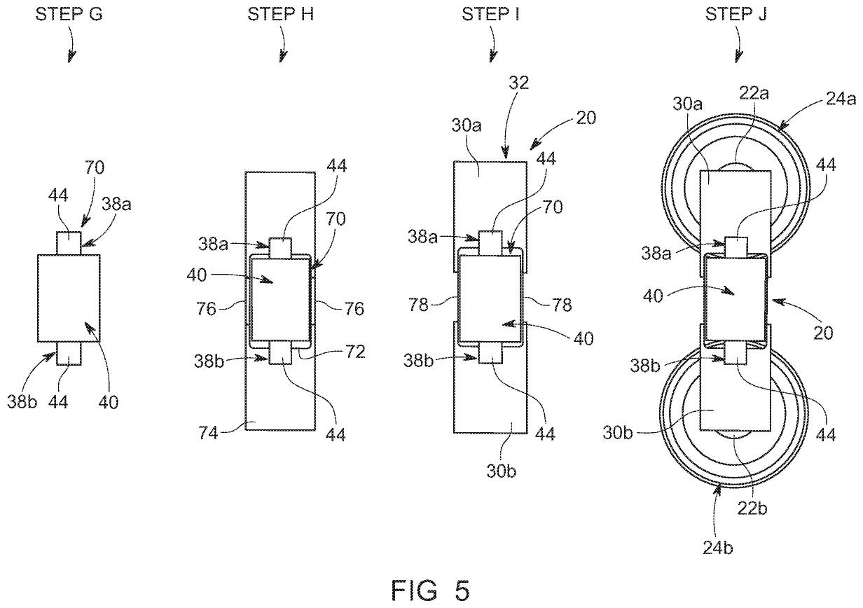

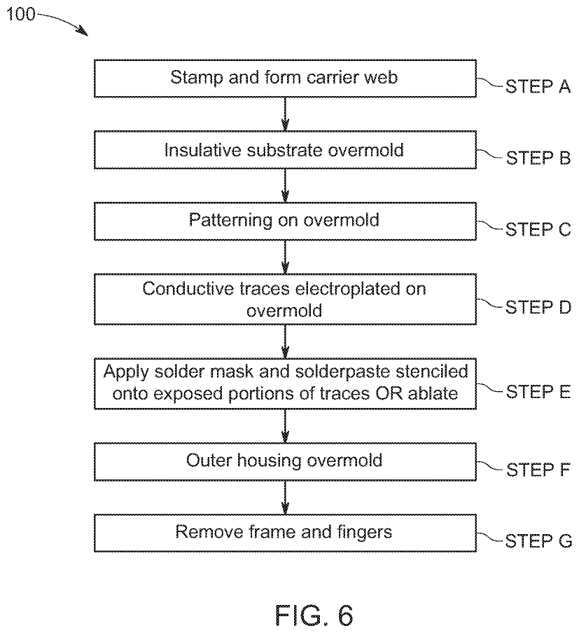

The fuse device 20 is preferably manufactured using the ASEP manufacturing process. Attention is invited to FIGS. 4 and 5, which illustrates the formation of the fuse device 20. FIG. 6 provides a flow chart showing steps of the ASEP manufacturing process 100.

When using the ASEP manufacturing process, the manufacturing process is preferably continuous for speed and cost reasons. Reel-to-reel technology allows the fuse device 20 to be formed while attached to a carrier web. The carrier web is preferably unspooled from a first (bulk source) reel (not shown) and then, if desired, collected in a second (take-up) reel (not shown), with the manufacturing process taking place between the first and second reels. As shown for example in U.S. Pat. No. 11,083,088, the carrier web has carrier holes 54 extending therethrough. The carrier holes 54 allow the carrier web to traverse along a manufacturing line in a continuous flow, like a conveyor belt, between the first and second reels. The carrier web is preferably formed of any desirable conductive metal, such as copper alloy.

As illustrated in FIGS. 4 and 6, the ASEP manufacturing process 100 begins with Step A. ASEP manufacturing process 100 preferably occurs between a pair of reels (not shown). In Step A, a middle portion of a continuous carrier web is stamped and formed (thus removing undesired portions of the middle portion of the carrier web) to form a lead frame 56 with an opening 58 and to form the first and second conductive plates 38a, 38b which extend inwardly into the opening 58. The lead frame 56 preferably includes end portions 56a, 56b (it being understood that the end portions 56a, 56b of one lead frame 56 are continuous with the end portions 56a, 56b of the adjacent lead frame 56), and a pair of stabilizing portions 56c, 56b (it being understood that stabilizing portions 56c, 56b of one lead frame 56 will also preferably act as stabilizing portions 56b, 56b of the adjacent lead frame 56), with each stabilizing portion 56c, 56b spanning the distance between the opposite end portions 56a, 56b. The opposite end portions 56a, 56b and the stabilizing portions 56c, 56b thus generally form a rectangular frame which defines the opening 58 therebetween. The first portions 42 of the conductive plates 38a, 38b are attached to the end portions 56a, 56b by fingers 60 and the second portions 44 of the conductive plates 38a, 38b are attached to the stabilizing portions 56c, 56b.

The ASEP manufacturing process 100 continues with Step B. In Step B, an insulative substrate is overmolded over the first portions 42 and sections of the second portions 42, 44 of the conductive plates 38a, 38b to form the inner insulative housing 34. The through holes 48a, 48b are formed in this overmolding step. The inner housing 34 may be formed of Acrylonitrile butadiene styrene (ABS), Polyphenylene sulfide (PPS), Syndiotactic Polystyrene (SPS), poly carbonate, poly carbonate blends, polypropylene, polypropylene blends. The inner housing 34 may also advantageously be formed with a thermally conductive liquid crystal polymer (LCP). By making the inner housing 34 out of thermally conductive LCPs, the heat loads of the electronics can be significantly reduced in the electrical connector 22. The overmolding of Step B can be performed with single or two shot processes, or any other conventional molding process.

The ASEP manufacturing process 100 continues with Step C. In Step C, patterning is performed on the inner housing 34. The patterning provides for a pattern 62 (which may be a circuit pattern) to be formed on the upper surface of the inner housing 34 and in the holes 48a, 48b. The pattern 62 includes plating 64a formed on the wall forming the through hole 48a, plating 66 formed on the upper surface of the inner housing 34, and plating 64b formed on the wall forming the through hole 48b. The plating 66 connects the platings 64a, 64b together. The pattern 62 can be formed by any number of suitable processes, including a laser process, a plasma process (which can be a vacuum or atmospheric process), a UV process and/or a fluorination process. Depending on the process used (e.g., plasma, UV and/or fluorination), the patterning may comprise patterning (i.e., a surface treatment of) most, if not all, of the upper surface of the inner housing 34. Thus, the pattern 62 may be formed on all or nearly all of the upper surface of the inner housing 34.

The ASEP manufacturing process 100 continues with Step D. In Step D, the pattern 62 is electroplated by applying a voltage potential to the lead frame 56 (which is electrically connected to the pattern 62) and then exposing the lead frame 56, the inner housing 34 and the pattern 62 to an electroplating bath to form the trace 36. The electroplating process not only electroplates the pattern 62 and the walls forming the through holes 48a, 48b, but also electroplates the lead frame 56 and the sections of the portions 44 and the fingers 60 that are not covered by the inner housing 34. A slug may be formed within the through holes 48a, 48b in the electroplating process. Step D can involve a single step plating process which builds up a single layer of a single material, such as copper, or can involve a multistep plating process which builds up multiple layers of multiple materials, such as a copper layer and a tin layer, it being understood that other suitable material could also be used. The increased thickness allows for increased current carrying capability and, in general, the electroplating process tends to create a material that has a high conductivity, such that the performance of the resultant electronic circuit trace 36 is improved.

The ASEP manufacturing process 100 continues with Step E, but FIG. 4 does not illustrate this step (Step E is shown in FIG. 6). In Step E, a solder mask is applied which covers select portions of the electronic circuit trace 36 and all, or substantially all, of the exposed surfaces of the inner housing 34 and solder paste is stenciled onto the exposed portions of the electronic circuit trace 36 (namely those portions not covered by the solder mask). Alternatively in Step E, a laser ablates tin that is plated over the nickel in areas around the perimeter of the components. Since tin is highly susceptible to soldering and nickel is not, the solder is prevented from flowing away from the components.

The manufacturing process continues with Step F. In Step F, an insulative substrate is overmolded to the inner housing 34 and over at least the conductive trace 36 to form the outer insulative housing 40. In the embodiment as shown, the outer housing 40 fully encapsulates the inner housing 34. In an embodiment, the outer housing 40 does not fully overlay the inner housing 34; the outer housing 40 only overlays the portions of the inner housing 34 which has the conductive trace 36. The second portions 44 are not encapsulated and extend outward from opposite ends of the outer housing 40. The overmolding of Step F can be performed with single or two shot processes, or any other conventional molding process.

The ASEP manufacturing process 100 continues with Step G, where Step G occurs located outside of the first and second reels. In Step G, the lead frame 56 and fingers 60 (if provided), are removed in order to form a fuse subassembly 70.

The manufacturing process continues with Step H. In Step H, the fuse subassembly 70 is seated within an aperture 72 in a conductive plate 74, with the second portions 44 of the fuse subassembly 70 overlapping the conductive plate 74. The second portions 44 are mechanically and electrically coupled to the conductive plate 74.

The manufacturing process continues with Step I. Sections 76 of the conductive plate 74 which are on the sides of the fuse subassembly 70 are removed to form gaps 78 and separate the conductive plate 74 into first and second sections thereby forming the fuse device 20. These sections form the conductive plates 30a, 30b.

In step J, which is outside of the manufacturing process, the fuse device 20 is attached to the battery cells 24a, 24b.

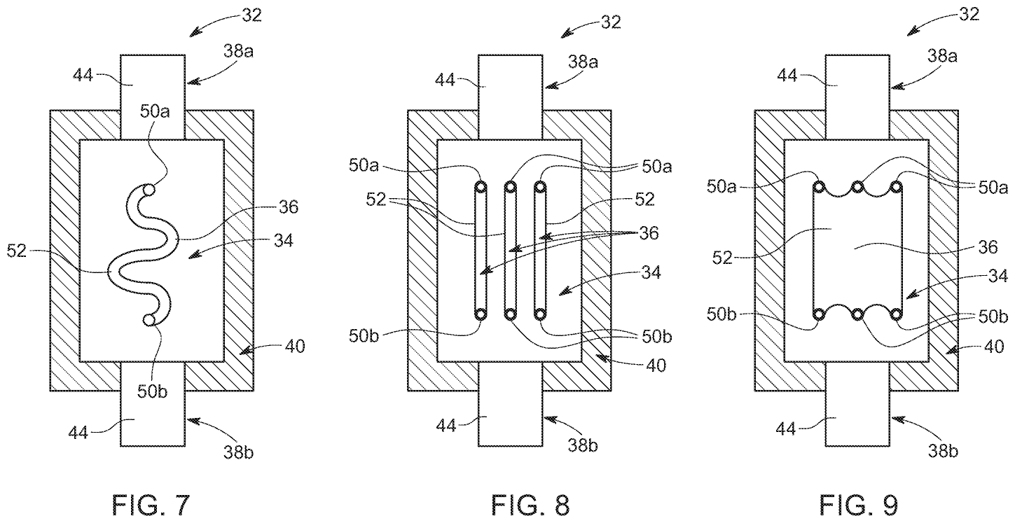

As shown in FIGS. 3 and 7-9, one or more conductive traces 36 can be provided on the inner insulative housing 34 for coupling to the conductive plates 38a, 38b. While the conductive trace 36 is shown as straight, the conductive trace 36 can take any desired form; for example, the conductive trace 36 can be serpentine, wavy, zigzag, etc. In addition, any desired width can be provided for the conductive trace 36, and the conductive trace 36 can include one or more plating 50a on the wall forming the through hole 48a, and one or more plating 50b on the wall forming the through hole 48b.

This fuse device 20 is formed by using the ASEP manufacturing process which allows the manufacturer to easily tune the fuse device 20 for each situation and allows for common stamped conductive plates 30a, 30b. Independent multiple fuse part numbers can be put into common stampings for fusing at various current-time profiles. In some embodiments, the conductive plates 30a, 30a are integrally formed as a single plate, and the conductive plates 30b, 38b are integrally formed as a single plate.

Furthermore, the fuse metallization of the fuse device 20 is encapsulated within the overmolded outer housing 40 to minimize cascading damage to other battery cells and electrical connections (i.e. shorts) when “blown”. Different shapes and patterns of the conductive trace 36 can be easily programmed with laser programming. In addition, different sizes for smaller or larger currents of the conductive trace 36 can be easily made.

It is to be appreciated that in certain applications not all of the Steps will be needed. It is to be further appreciated that in certain applications the order of Steps may be modified as appropriate.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. As can be appreciated from the various embodiments depicted herein, different features of different embodiments depicted herein can be combined together to form additional combinations. As a result, the embodiments depicted herein are particularly suitable to provide a wide range of configurations that were not all depicted individually so as to avoid repetitiveness and unnecessary duplication.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A method of forming a fuse device for coupling terminals of a pair of battery cells, comprising:
stamping and forming a lead frame defining an opening and having first and second conductive plates extending into the opening;
overmolding a first insulative housing onto a first section of each of the first and second conductive plates without overmolding a second section of each of the first and second conductive plates, thereby coupling the first and second conductive plates together;
forming a trace on the first insulative housing which is mechanically and electrically coupled to the first and second conductive plates;
overmolding an insulative second housing over at least the trace thereby forming a subassembly;
singulating the subassembly from the from the lead frame;
mechanically and electrically coupling the second section of the first conductive plate to a third conductive plate; and
mechanically and electrically coupling the second section of the second conductive plate to a fourth conductive plate.

2. The method as defined in claim 1, wherein the third conductive plate is coupled to one of the terminals of one of the battery cells and the fourth conductive plate is coupled to one of the terminals of the other battery cell.

3. The method as defined in claim 1, wherein the second insulative housing is overmolded over the entire first housing.

4. The method as defined in claim 1, wherein the first housing has a first opening provided therethrough which exposes a section of the first section of the first conductive plate and a second opening provided therethrough which exposes a section of the first section of the second conductive plate, wherein the trace is formed by:
forming a pattern on the first insulative housing, wherein the pattern extends along a surface of the first insulative housing and through the openings, and
thereafter electroplating the pattern.

5. The method as defined in claim 4, wherein the second insulative housing is overmolded over the entire first housing.

6. The method as defined in claim 4, wherein the third conductive plate is coupled to one of the terminals of one of the battery cells and the fourth conductive plate is coupled to one of the terminals of the other battery cell.

7. The method as defined in claim 1, wherein the first housing has a plurality of first openings provided therethrough each of which exposes a section of the first section of the first conductive plate and a plurality of second opening provided therethrough each of which exposes a section of the first section of the second conductive plate, wherein the trace is formed by:
forming a plurality of patterns on the first insulative housing, wherein each pattern extends along a surface of the first insulative housing, through one of the first openings and through one of the first openings, and
thereafter electroplating the patterns.

8. The method as defined in claim 1, wherein the first housing has a plurality of first openings provided therethrough each of which exposes a section of the first section of the first conductive plate and a plurality of second opening provided therethrough each of which exposes a section of the first section of the second conductive plate, wherein the trace is formed by:
forming a pattern on the first insulative housing, wherein the pattern extends along a surface of the first insulative housing, through each of the first openings and through each of the first openings, and
thereafter electroplating the pattern.

9. The method as defined in claim 1, wherein the trace has one of a straight portion, a serpentine portion, a wavy portion, a zigzag portion.

10. A method of forming a fuse device for coupling terminals of a pair of battery cells, comprising:
stamping and forming a lead frame defining an opening and having first and second conductive plates extending into the opening;
overmolding a first insulative housing onto a first section of each of the first and second conductive plates without overmolding a second section of each of the first and second conductive plates, thereby coupling the first and second conductive plates together;
forming a trace on the first insulative housing which is mechanically and electrically coupled to the first and second conductive plates;
overmolding an insulative second housing over at least the trace thereby forming a subassembly;
singulating the subassembly from the from the lead frame;
positioning the subassembly within an opening in a third conductive plate;
mechanically and electrically coupling the second section of each of the first and second conductive plates with the third conductive plate; and
removing portions of the third conductive plate to separate the third conductive plate into first and second sections.

11. The method as defined in claim 10, wherein the first section of the third conductive plate is coupled to one of the terminals of one of the battery cells and the second section of the third conductive plate is coupled to one of the terminals of the other battery cell.

12. The method as defined in claim 10, wherein the second insulative housing is overmolded over the entire first housing.

13. The method as defined in claim 10, wherein the first housing has a first opening provided therethrough which exposes a section of the first section of the first conductive plate and a second opening provided therethrough which exposes a section of the first section of the second conductive plate, wherein the trace is formed by:
forming a pattern on the first insulative housing, wherein the pattern extends along a surface of the first insulative housing and through the openings, and
thereafter electroplating the pattern.

14. The method as defined in claim 13, wherein the second insulative housing is overmolded over the entire first housing.

15. The method as defined in claim 13, wherein the first section of the third conductive plate is coupled to one of the terminals of one of the battery cells and the second section of the third conductive plate is coupled to one of the terminals of the other battery cell.

16. The method as defined in claim 10, wherein the first housing has a plurality of first openings provided therethrough each of which exposes a section of the first section of the first conductive plate and a plurality of second opening provided therethrough each of which exposes a section of the first section of the second conductive plate, wherein the trace is formed by:
forming a plurality of patterns on the first insulative housing, wherein each pattern extends along a surface of the first insulative housing, through one of the first openings and through one of the first openings, and
thereafter electroplating the patterns.

17. The method as defined in claim 10, wherein the first housing has a plurality of first openings provided therethrough each of which exposes a section of the first section of the first conductive plate and a plurality of second opening provided therethrough each of which exposes a section of the first section of the second conductive plate, wherein the trace is formed by:
forming a pattern on the first insulative housing, wherein the pattern extends along a surface of the first insulative housing, through each of the first openings and through each of the first openings, and
thereafter electroplating the pattern.

18. The method as defined in claim 10, wherein the trace has one of a straight portion, a serpentine portion, a wavy portion, a zigzag portion.

19. A fuse device comprising:
a subassembly including a first insulative housing, a first conductive plate having a first section encapsulated within the first insulative housing and a second section extending from the first insulative housing, a second conductive plate having a first section encapsulated within the first insulative housing and a second section extending from the first insulative housing, a conductive trace on the first insulative housing which is electrically and mechanically coupled to the first sections, and a second insulative housing over at least the trace;
a third conductive plate to which the second section of the first conductive plate is mechanically and electrically coupled;
a fourth conductive plate to which the second section of the second conductive plate is mechanically and electrically coupled; and
wherein the subassembly is formed by an Application Specific Electronics Packaging (“ASEP”) manufacturing process comprising stamping and forming a lead frame defining an opening and having first and second conductive plates extending into the opening, overmolding a first insulative housing onto a first section of each of the first and second conductive plates without overmolding a second section of each of the first and second conductive plates, thereby coupling the first and second conductive plates together, forming a trace on the first insulative housing which is mechanically and electrically coupled to the first and second conductive plates, overmolding an insulative second housing over at least the trace thereby forming a subassembly, and singulating the subassembly from the from the lead frame.

20. The fuse device as defined in claim 19, wherein the second insulative housing encapsulates the first insulative housing, and the conductive trace.
